(19) United States
(12) Patent Application Publication
(10) Pub. No.: US 2011/0186675 A1
(43) Pub. Date: Aug. 4, 2011

(54) WEBBING TAKE-UP DEVICE

(75) Inventors: Takahiro OSAKI, Aichi-ken (JP); Shinji MORI, Aichi-ken (JP)

(73) Assignee: KABUSHIKI KAISHA TOKAI-RIKA-DENKI-SEISAKUSHO, Aichi-ken (JP)

(21) Appl. No.: 13/018,812

(22) Filed: Feb. 1, 2011

(30) Foreign Application Priority Data
Feb. 3, 2010 (JP) 2010-022445

(51) Int. Cl. B60R 22/44; B65H 75/48

(52) U.S. Cl. 242/372

(57) ABSTRACT

A webbing take-up device with a small difference in a frictional force between an outermost layer portion of a spiral spring along a circumferential direction of a rotating body and an inner peripheral portion of the rotating body is obtained. A reduction sliding spring is formed in a curved shape, such that the radius of curvature becomes gradually larger in a predetermined ratio toward a longitudinal central portion from both longitudinal ends in a state where the reduction sliding spring has not been elastically deformed in a circular shape. The amount of elastic deformation accompanying a minute change in a position from the longitudinal central portion to both longitudinal ends becomes approximately equal in a state where the reduction sliding spring has been elastically deformed in the circular shape. Therefore, a radially outward elastic force having substantially a center of the reduction sliding spring as its center becomes approximately equal.

### CROSS-REFERENCE TO RELATED APPLICATION

This application claims priority under 35 USC 119 from Japanese Patent Application No. 2010-022445 filed Feb. 3, 2010, the disclosure of which is incorporated by reference herein.

### BACKGROUND

1. Technical Field

The present invention relates to a webbing take-up device including a tension reducer which can make a biasing force biasing a webbing belt in a take-up direction to be small in a state in which the webbing belt which constrains an occupant's body is worn.

2. Related Art

In a webbing take-up device disclosed in Japanese Patent Application Laid-Open (JP-A) No. 2006-290343, a balance spring which constitutes a tension reducer is constituted by a so-called “spiral spring”. The balance spring is housed inside a ratchet wheel, and an extension spring constituted by a plate spring is provided between an outermost layer portion of a balance spring including an outer end in a spiral direction, and a second layer portion of the balance spring adjacent to the outermost layer portion inside the outermost layer portion.

This extension spring biases the outermost layer portion outward in the direction of the radius of rotation of the ratchet wheel in a state where the extension spring is provided between the outermost layer portion of the balance spring, and the second layer portion. The outermost layer portion of the balance spring is brought into pressure contact with the inner peripheral portion of the ratchet wheel by the biasing force of this extension spring. In a case where the inner end of the balance spring in the spiral direction has been rotated (displaced) in the take-up direction in a state where the rotation of the ratchet wheel in the take-up direction is regulated, the rotation (displacement) of the outermost layer portion of the balance spring in the take-up direction is regulated so as to follow the inner end in the spiral direction.

However, since the shape in a state where this extension spring is not elastically deformed is substantially circular, a biasing force which biases the outermost layer portion of the balance spring varies in the circumferential direction. Since the magnitude of the frictional force between the balance spring and the ratchet wheel depends on the magnitude of the biasing force of the extension spring, when variation occurs in the biasing force of the extension spring, the above frictional force has a difference in magnitude in the circumferential direction.

### SUMMARY

The invention provides a webbing take-up device with a small difference in a frictional force between an outermost layer portion of a spiral spring along the circumferential direction of a rotating body and an inner peripheral portion of the rotating body in consideration of the above facts.

A webbing take-up device of a first aspect of the invention is a webbing take-up device including a spool having a longitudinal base end of an elongated belt-shaped webbing belt locked thereto, taking up the webbing belt from the base end by rotating in a take-up direction, and rotating in a pull-out direction opposite to the take-up direction as the webbing belt is pulled out; a spool biasing member biasing the spool in the take-up direction by a take-up biasing force which increases with the rotation of the spool in the pull-out direction; a rotating body formed in a bottomed shape having a peripheral wall whose inner peripheral shape is circular, and rotating around an axis having the same axial direction as an axial direction of the spool, the rotation of the rotating body according to the rotation of the spool in the take-up direction being regulated in a state where the webbing belt is applied to an occupant's body; a spiral spring provided inside the rotating body, the spiral spring having an inner end in a spiral direction connected directly or indirectly to the spool, the inner end in the spiral direction being wound around and tightened to an outer end in the spiral direction as the spool rotates in the take-up direction in a state where the rotation of the rotating body is regulated, such that a biasing force biasing the spool in the pull-out direction is generated; and a pressure-contact biasing member biasing an outermost layer portion located at a outermost side in the spiral spring radially outward from a center of an inner peripheral portion of the rotating body, and pressing the outermost layer portion to contact with the inner peripheral portion of the rotating body, the biasing force being substantially uniformly set in a circumferential direction of the inner peripheral portion.

According to the webbing take-up device of the first aspect of the invention, the spool rotates in the pull-out direction when an occupant of a vehicle pulls out the webbing belt from the spool. When the spool rotates in the pull-out direction in this way, the take-up biasing force is generated by the spool biasing member, and the spool is biased in the take-up direction opposite to the pull-out direction. Additionally, the inner end of the spiral spring in the spiral direction housed inside the rotating body is connected to the spool. Thus, when the spool rotates in the pull-out direction or the take-up direction, this rotation is transmitted to the inner end of the spiral spring in the spiral direction, and the inner end of the spiral spring in the spiral direction is rotated. The outermost layer portion of this spiral spring is brought into pressure contact with the inner peripheral portion of the rotating body by the biasing force of the pressure-contact biasing member. For this reason, when the inner end of the spiral spring in the spiral direction rotates as described above, the outermost layer portion of the spiral spring rotates together, and the rotating body rotates along with the outermost layer portion due to the friction with the outermost layer portion.

Meanwhile, when the webbing belt pulled out from the spool is applied to an occupant's body as described above, and for example, a tongue provided at the webbing belt is mounted on a buckle, the rotation of the rotating body interlocked with the rotation of the spool in the take-up direction is regulated. In this state, if the pulling of the webbing belt when the webbing belt is worn is eliminated, the spool is rotated in the take-up direction such that the take-up biasing force of the spool biasing member eliminates loosening of the webbing belt.

When the spool rotates in the take-up direction in this way, the inner end of the spiral spring in the spiral direction rotates in the take-up direction. On the other hand, since the rotation of the rotating body interlocked with the rotation of the spool in the take-up direction is regulated, the displacement of the outermost layer portion of the spiral spring, which is brought into pressure contact with the inner peripheral portion of the rotating body, in the take-up direction is regulated by the friction with the inner peripheral portion of the rotating body. For this reason, in this state, the inner end of the spiral spring in the spiral direction is displaced in the take-up direction with respect to the outermost layer portion, and thereby, a biasing force which biases the spool in the pull-out direction is generated.

Since the biasing force generated in this spiral spring acts so as to resist the take-up biasing force of the spool biasing member, the take-up biasing force of the spool biasing member is offset by the biasing force of the spiral spring, and the force which biases the spool in the take-up direction decreases. As the force which biases the spool in the take-up direction decreases in this way, the force which pulls the webbing belt toward the base end decreases, and the force with which the webbing belt applied to an occupant's body fastens the occupant's body decreases.

Here, although the pressure-contact biasing member which biases the outermost layer portion of the spiral spring biases the outermost layer portion of the spiral spring radially outward, this biasing force is set so as to become substantially uniform in the circumferential direction of the rotating body. For this reason, the overall portion of the outermost layer portion of the spiral spring corresponding to the pressure-contact biasing member is substantially uniformly brought into pressure contact with the inner peripheral portion of the rotating body. For this reason, the friction generated between the portion of the outermost layer portion of the spiral spring corresponding to the pressure-contact biasing member, and the inner peripheral portion of the rotating body becomes substantially uniform in the circumferential direction of the rotating body. As a result, the braking torque between the rotating body of which the rotation is regulated, and the outermost layer portion of the spiral spring to be displaced in the take-up direction along with the inner end in the spiral direction is stabilized.

A webbing take-up device of a second aspect of the invention is the webbing take-up device according to the first aspect of the invention in which the pressure-contact biasing member is provided with a spring member; the spring member is bent with a radial inside of the inner peripheral portion of the rotating body as a center of radius of curvature; the spring member is provided between the outermost layer portion of the spiral spring and a second layer portion adjacent to the outermost layer portion further toward an inner side in the spiral direction than the outermost layer portion in the state of being elastically deformed, such that a radius of curvature on a central side is set to be larger than on both end sides in the circumferential direction and a difference in the radius of curvature between both end sides in the circumferential direction and the central side is decreased; and the spring member biases the outermost layer portion radially outward by the biasing force generated by being elastically deformed.

According to the webbing take-up device of the second mode of the invention, a spring member serving as the pressure-contact biasing member is provided between the outermost layer portion of the spiral spring and a second layer portion adjacent to the outermost layer portion on the inner side with respect to the outermost layer portion. This spring member is bent with the radial inside of the inner peripheral portion of the rotating body as the center of radius of curvature, and is set such that the radius of curvature on the central side is larger than on both end sides of the spiral member along the circumferential direction of the rotating body. This spring member is elastically deformed toward the center of the radius of curvature such that there is a difference in radius of curvature between both end sides and the central side is decreased, and is provided between the outermost layer portion of the spiral spring, and the second layer portion in this state. The outermost layer portion of the spiral spring is biased radially outward by the biasing force of the spring member provided in this way, and is brought into pressure contact with the inner peripheral portion of the rotating body.

Here, the spring member has a larger radius of curvature on the central side than on the outside in the circumferential direction as described above. For this reason, when the spring member is elastically deformed in the circular shape, the difference in the amount of elastic deformation according to a minute amount of change in the position from the center of the spring member in the circumferential direction to both ends thereof becomes small. Here, a biasing force which biases the outermost layer portion of the spiral spring radially outward is set so as to become substantially uniform in the circumferential direction of the rotating body.

In addition, in the invention, the spring member is set such that the radius of curvature is set to be larger on the central side than on the outside in the circumferential direction as described above. However, it is preferable to set the shape of the spring member such that the radius of curvature becomes gradually larger so as to draw a so-called “relaxation curve” from both ends of the spring member along the circumferential direction of the rotating body to the center thereof.

A webbing take-up device of a third aspect of the invention is the webbing take-up device according to the second aspect of the invention in which the shape of the spring member is set such that both ends of the spring member are located inward so as to be separated from the outermost layer portion of the spiral spring in a state where the spring member has been elastically deformed substantially in a circular shape.

According to the webbing take-up device of the third aspect of the invention, if the spring member is elastically deformed when the spring member is arranged between the outermost layer portion and second layer portion of the spiral spring, both ends of the spring member along the circumferential direction of the rotating body are directed to the inside of the spring member. For this reason, when the spring member which has been elastically deformed in this way is arranged between the outermost layer portion and second layer portion of the spiral spring, both ends of the spring member do not come into contact with the outermost layer portion of the spiral spring. For this reason, corners of both ends of the spring member do not contact the outermost layer portion of the spiral spring partially.

### BRIEF DESCRIPTION OF THE DRAWINGS

Exemplary Embodiments of the present invention will be described in detail based on the following figures, wherein:

FIG. 1 is an exploded perspective view of chief parts of a webbing take-up device related to one embodiment of the invention.

FIG. 2 is a front sectional view of the chief parts of the webbing take-up device related to one embodiment of the invention.

FIG. 3 is a side view showing a rotating body and a mechanism which regulates the rotation of the rotating body in a take-up direction, which constitute the webbing take-up device related to one embodiment of the invention.

FIG. 4 is a side view of the rotating body as seen from the side opposite to FIG. 3.

FIG. 5A is a front view showing an elastically deformed state of a pressure-contact biasing member.

FIG. 5B is a front view showing a state before elastic deformation of the pressure-contact biasing member.

FIG. 6A is a front view showing an elastically deformed state of a modification of a pressure-contact biasing member.

FIG. 6B is a front view showing a state before elastic deformation of the modification of the pressure-contact biasing member.

### DETAILED DESCRIPTION

<Configuration of Present Embodiment>

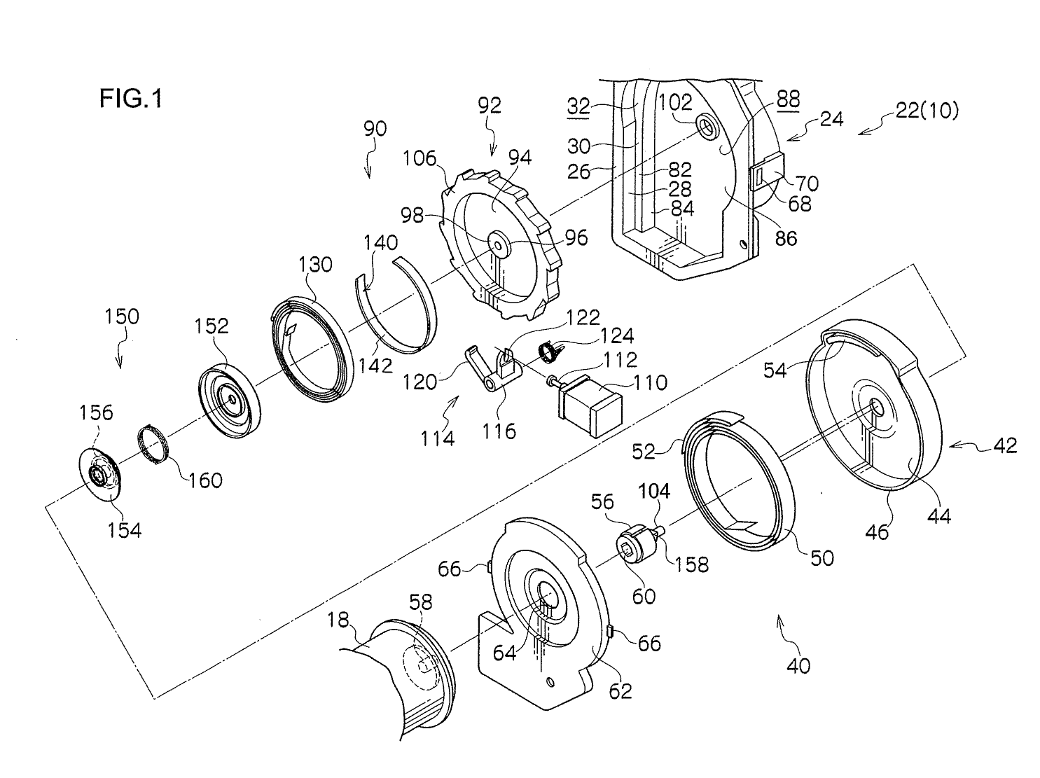

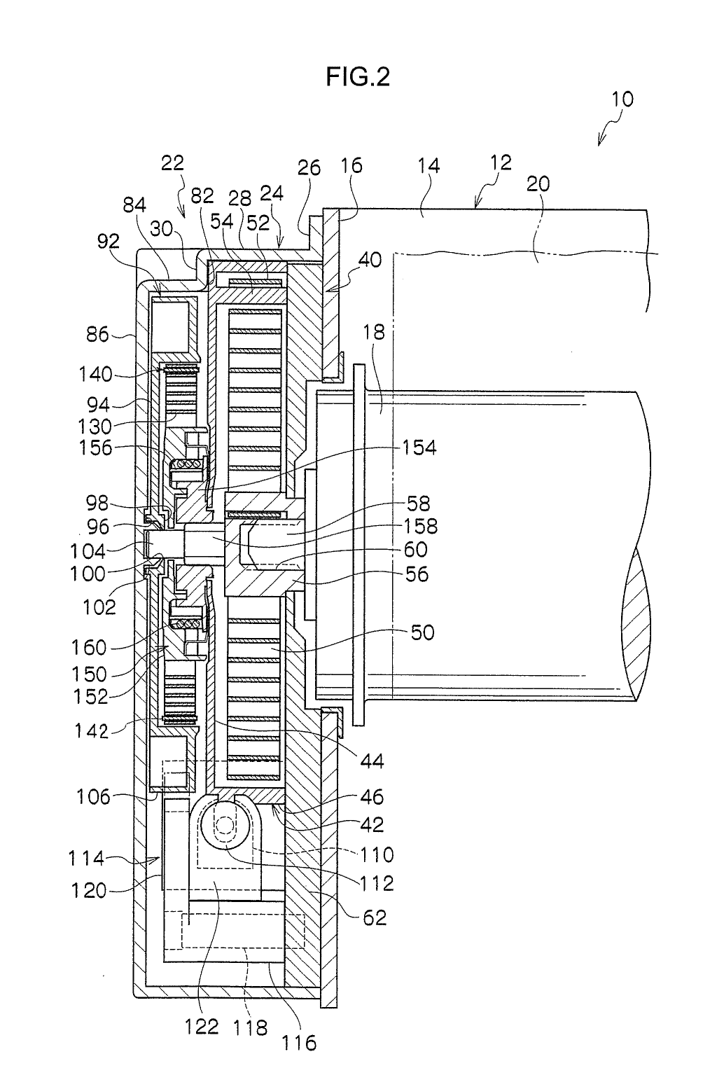

The configuration of chief parts of a webbing take-up device 10 related to one embodiment of the invention is shown by an exploded perspective view in FIG. 1, and the configuration of the chief parts of the webbing take-up device 10 is shown by a front sectional view in FIG. 2.

As shown in FIG. 2, the webbing take-up device 10 includes a frame 12. The frame 12 includes a back plate 14. A leg plate 16 extends toward one side of the back plate 14 in its thickness direction from one end of the back plate 14 in its width direction, and a leg plate (not shown) extends toward an extending direction of the leg plate 16 with respect to the back plate 14 from the other end of the back plate 14 in the width direction. A spool 18 is provided between the leg plate 16 extending from one end of the back plate 14 in the width direction and the leg plate (not shown) extending from the other end of the back plate 14 in the width direction. As shown in FIG. 1, the spool 18 is formed in a cylindrical shape of which the axial direction runs along the width direction of the back plate 14.

A longitudinal base end of the webbing belt 20 which is formed in an elongated belt shape is locked to the spool 18. When the spool 18 rotates in the take-up direction which is one side around the axis thereof, the webbing belt 20 is taken up around the outer peripheral portion of the spool 18 from the longitudinal base end. On the other hand, when the webbing belt 20 is pulled toward its tip, the webbing take-up device 10 rotates in a pull-out direction opposite to the take-up direction while the webbing belt 20 taken up around the spool 18 is pulled out from the spool 18.

Meanwhile, a case 24 which constitutes a tension reducer 22 is provided outside the leg plate 16 along the width direction of the back plate 14. The case 24 includes a plate-shaped base 26 of which the thickness direction runs along the thickness direction of the leg plate 16, and the base 26 is fixed to the leg plate 16 by a tightening and fixing means, such as a screw, or a fitting and fixing means, such a baluster pin. The base 26 is formed with a hole of a predetermined shape, and an annular peripheral wall 28 along the edge of this hole is formed toward the side of the base 26 opposite to the leg plate 16. A middle wall 30 is formed at the end of the peripheral wall 28 opposite to the base 26 continuously from the peripheral wall 28. The middle wall 30 is formed in the shape of a plate of which the thickness direction runs along the thickness direction of the base 26, and the space surrounded by the peripheral wall 28 on the side closer to the base 26 than the middle wall 30 is used as a take-up spring unit housing portion 32 (refer to FIG. 1).

The take-up spring unit 40 is arranged inside the take-up spring unit housing portion 32. The take-up spring unit 40 includes a spring cover 42 serving as a holding body. The spring cover 42 includes a plate-shaped bottom wall 44. A peripheral wall 46 is erected toward the leg plate 16 from the outer peripheral portion of the bottom wall 44, and the spring cover 42 is formed in the shape of a box which opens toward the leg plate 16 as a whole. The outer peripheral shape of the spring cover 42 is slightly smaller than the inner peripheral shape (i.e., the inner peripheral shape of the peripheral wall 28) of the take-up spring unit housing portion 32, and the spring cover 42 is fitted in a state in which the rotation of the spring cover with respect to the case 24 is prevented inside the take-up spring unit housing portion 32.

A take-up spring 50 serving as a spool biasing member is provided inside the spring cover 42. The take-up spring 50 is constituted by a power spring in which the direction to the inside in a spiral direction from the outside in the spiral direction becomes the pull-out direction. A locking portion 52 is formed near the outer end of the take-up spring 50 in the spiral direction such that the take-up spring 50 is folded back in an opposite direction, and is locked to a locking wall 54 erected toward the leg plate 16 from the bottom wall 44. On the other hand, the inner end of the take-up spring 50 in the spiral direction is locked to the outer peripheral portion of an adapter 56 which constitutes a rotation transmission member serving as a connecting member.

The adapter 56 is formed in a columnar shape made substantially coaxially with the spool 18. The end of the adapter 56 which faces the axial end of the spool 18 on the leg plate 16 side is formed with a fitting hole 60 into which a connecting shaft portion 58 formed to protrude from the spool 18 coaxially with the spool 18 fits. As the connecting shaft portion 58 fits into the fitting hole 60, the spool 18 and the adapter 56 are connected together in a state in which the adapter 56 cannot rotate relative to the spool 18.

For this reason, when the webbing belt 20 is pulled toward its tip and the spool 18 is rotated in the pull-out direction, the inner end of the take-up spring 50 in the spiral direction rotates relatively in the pull-out direction with respect to the outer end in the spiral direction. As the take-up spring 50 is wound and tightened in this way, the spool 18 is biased in the take-up direction, and as the rotational amount in the pull-out direction of the inner end of the take-up spring 50 in the spiral direction relative to the outer end of the take-up spring 50 in the spiral direction becomes larger, the biasing force is increased.

A sheet 62 is provided on the opening side of the spring cover 42 in which the take-up spring 50 is housed. The sheet 62 is formed in the shape of a plate of which the thickness direction runs along the thickness direction of the leg plate 16. The sheet 62 is formed with a through hole 64 through which the adapter 56 passes. Additionally, fitting pieces 66 extend from a portion of the outer periphery of the sheet 62. Fitting portions 70 each having a fitting hole 68 are formed on the above back plate 14 so as to correspond to the fitting pieces 66. By fitting the fitting pieces 66 into the fitting holes 68 of the fitting portions 70, the sheet 62 is integrally attached to the back plate 14, and the opening side of the take-up spring unit housing portion 32 in a back plate 14 and the opening side of the spring cover 42 are closed.

Meanwhile, the middle wall 30 of the back plate 14 is formed with a hole portion 82 of a predetermined shape. Moreover, a peripheral wall 84 along the edge of the hole portion 82 is formed on the face of the middle wall 30 opposite to the leg plate 16. The end of the peripheral wall 84 opposite to the middle wall 30 is closed by a bottom wall 86, the inside of the peripheral wall 84 closer to the middle wall 30 than the bottom wall 86 is used as a reduction spring unit housing portion 88, and the reduction spring unit 90 is housed in the reduction spring unit housing portion 88. The reduction spring unit 90 includes a ratchet gear 92 serving as a rotating body.

The ratchet gear 92 includes a plate-shaped bottom wall portion 94 of which the thickness direction runs along the thickness direction of the bottom wall 86. A boss 96 is formed at the center of the bottom wall portion 94. The boss 96 is formed in the shape of a bottomed cylinder which opens toward the bottom wall 86. The portion of the boss 96 closer to one side (the opening side of the boss 96) than an axial intermediate portion of the boss protrudes to the bottom wall 86 side of the bottom wall portion 94, and the portion of the boss 96 closer to the other side (the bottom 98 side of the boss 96) than the axial intermediate portion of the boss protrudes to the leg plate 16 side of the bottom wall portion 94.

The inner peripheral shape of the boss 96 is formed in a circular shape which is coaxial with the circular outer peripheral shape. Moreover, the bottom 98 is formed with a through hole 100 which is coaxial with the inner peripheral shape of the boss 96. The through hole 100 not only passes through the bottom 98, but also is formed in the shape of a circular truncated cone of which the internal diameter dimension becomes gradually smaller toward an opening end of the bottom 98 in the face on the side of the leg plate 16.

As shown in FIGS. 1 and 2, a bearing 102 which constitutes both a first supporting means and a second supporting means serving as circular bodies is formed at the bottom wall 86 of the case 24 so as to correspond to the boss 96. The bearing 102 is formed in the shape of a cylinder which is coaxial with the spool 18 in a state in which the case 24 is attached to the leg plate 16. However, the tip side of the bearing 102 is formed in the shape of a circular truncated cone of which the external diameter dimension becomes gradually smaller toward the tip so as to correspond to the through hole 100 formed in the bottom 98 of the boss 96. The boss 96 enters the outside of the bearing 102 in a state in which the ratchet gear 92 is arranged within the reduction spring unit housing portion 88, and the ratchet gear 92 is rotatably supported by the boss 96. Moreover, a shaft portion 104 which is formed integrally with the adapter 56 formed in a columnar shape coaxially with the spool 18 enters the inside of the boss 96, and the shaft portion 104 (i.e., the adapter 56) is rotatably supported.

The outer peripheral portion of the bottom wall portion 94 is formed with a ratchet portion 106, and the ratchet gear 92 is formed in the shape of a tray (a bottomed tube of which the axial dimension is comparatively short) which opens toward the leg plate 16 as a whole. A solenoid 110 is provided radially outside the ratchet portion 106 (below the ratchet portion 106 in the present embodiment). The solenoid 110 is electrically connected to a battery loaded on a vehicle via an ECU serving as a control means. Moreover, the ECU is electrically connected to a buckle switch provided at a buckle device which constitutes a seat belt device along with the webbing take-up device 10. When the buckle switch detects that a tongue plate provided at the above webbing belt 20 is mounted on the buckle device, the ECU brings the solenoid 110 into an energized state. When the solenoid 110 is brought into an energized state in this way, the solenoid 110 forms a magnetic field.

Additionally, the solenoid 110 is provided with a plunger 112. The plunger 112 is formed in the shape of a rod from a magnetic body, and its longitudinal base end enters the solenoid 110. When the solenoid 110 is energized as described above, the plunger 112 is further drawn into the inside of the solenoid 110 by the magnetic field which the solenoid 110 forms. A pawl 114 is provided on the tip side of the plunger 112. The pawl 114 includes a cylindrical portion 116. The axial direction of the cylindrical portion 116 becomes the same direction as the axial direction of the spool 18. A shaft portion 118 (refer to FIG. 2) of which at least one end is held by at least any one of the sheet 62 and the case 24 passes through the cylindrical portion 116, and the pawl 114 is rotatably supported around the shaft portion 118. A rotation regulating piece 120 extends from a portion of the outer periphery of the cylindrical portion 116.

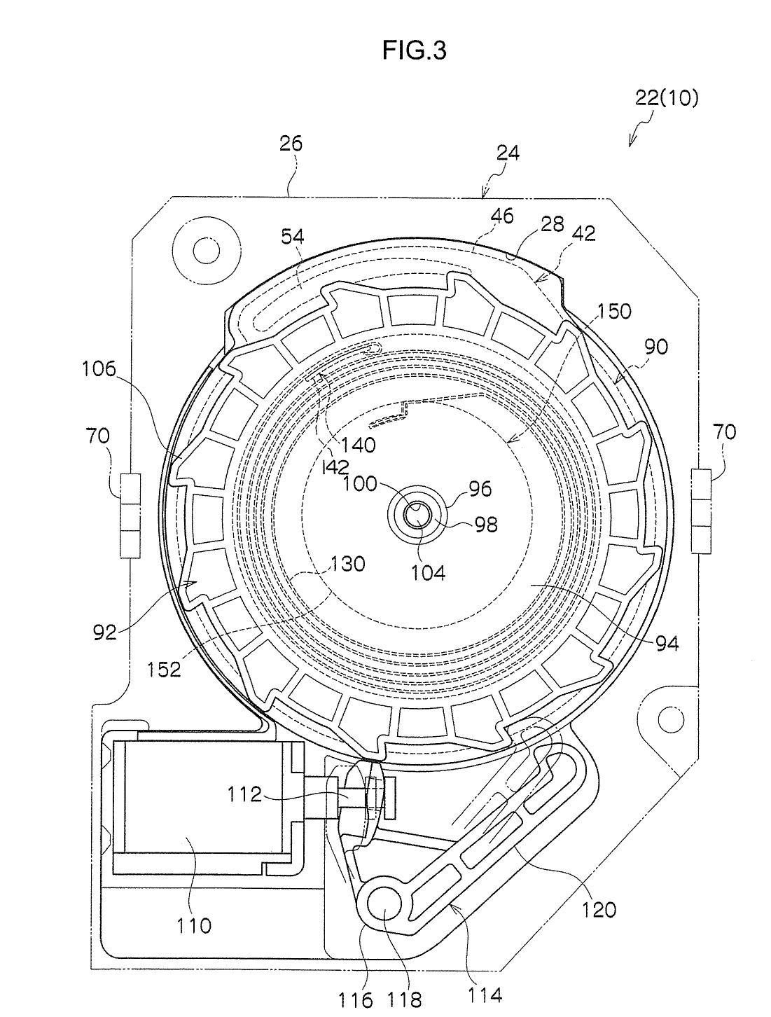

When the pawl 114 turns in an engaging direction which is one side around the shaft portion 118 as shown in FIG. 3, the tip of the rotation regulating piece 120 approaches the outer peripheral portion of the ratchet portion 106 and engages with the ratchet gear teeth of the ratchet portion 106. In a state in which the tip of the rotation regulating piece 120 has engaged with the ratchet gear teeth of the ratchet portion 106, the rotation of the ratchet gear 92 in the take-up direction is regulated. Additionally, a connecting piece 122 extends from a portion of the outer periphery of the cylindrical portion 116. The pawl 114 is connected to the plunger 112 by the connecting piece 122. When the plunger 112 is drawn into the solenoid 110, the connecting piece 122 is pulled by the plunger 112 and the pawl 114 turns in the engaging direction around the shaft portion 118. Additionally, one end of a return spring 124 is locked to the pawl 114, and the pawl 114 is biased in a direction opposite to the engaging direction. When the solenoid 110 is not energized, the tip side of the rotation regulating piece 120 is maintained in the state of being separated from the outer peripheral portion of the ratchet portion 106.

Meanwhile, a reduction balance spring 130 serving as a “spiral spring” set forth in the claims which constitutes the reduction spring unit 90 is arranged inside the ratchet gear 92 (i.e., inside the ratchet portion 106 on the leg plate 16 side of the bottom wall portion 94). The reduction balance spring 130 is constituted by a flat spiral spring which has a biasing force weaker than the take-up spring 50 and in which the direction to the inside in the spiral direction from the outside in the spiral direction becomes the take-up direction.

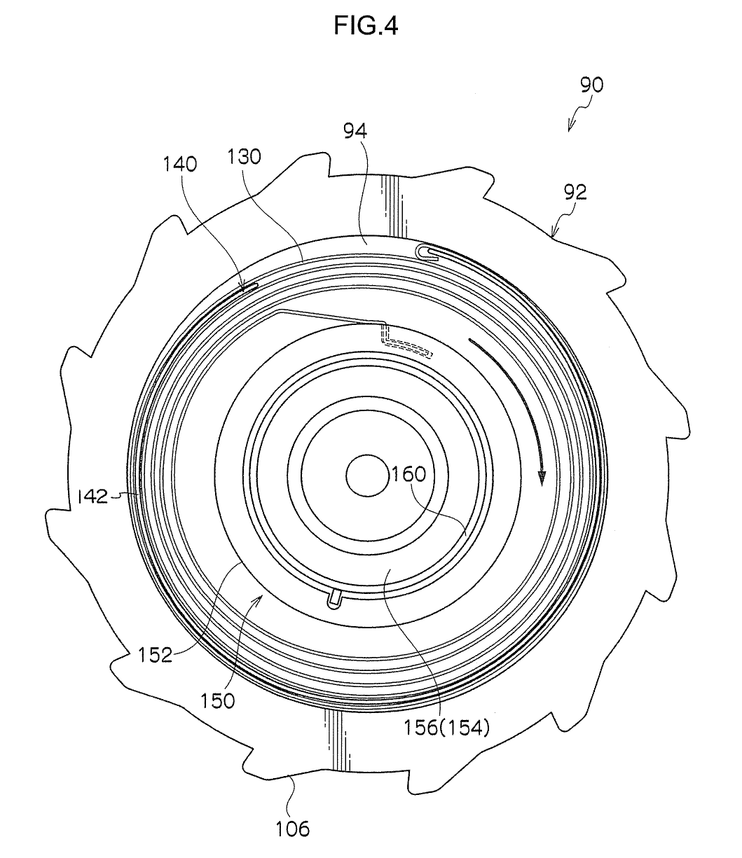

As shown in FIGS. 3 and 4, the reduction balance spring 130 is bent inward in the radial direction and inward in the spiral direction near its outer end in the spiral direction. A reduction sliding spring 140 which constitutes a “pressure-contact biasing member” serving as a “spring member” set forth in the claims is arranged between an outermost layer portion (outermost portion of a spiral) of the reduction balance spring 130 in the spiral direction, and a second layer portion (second portion from the outside of the spiral) from the outermost layer portion.

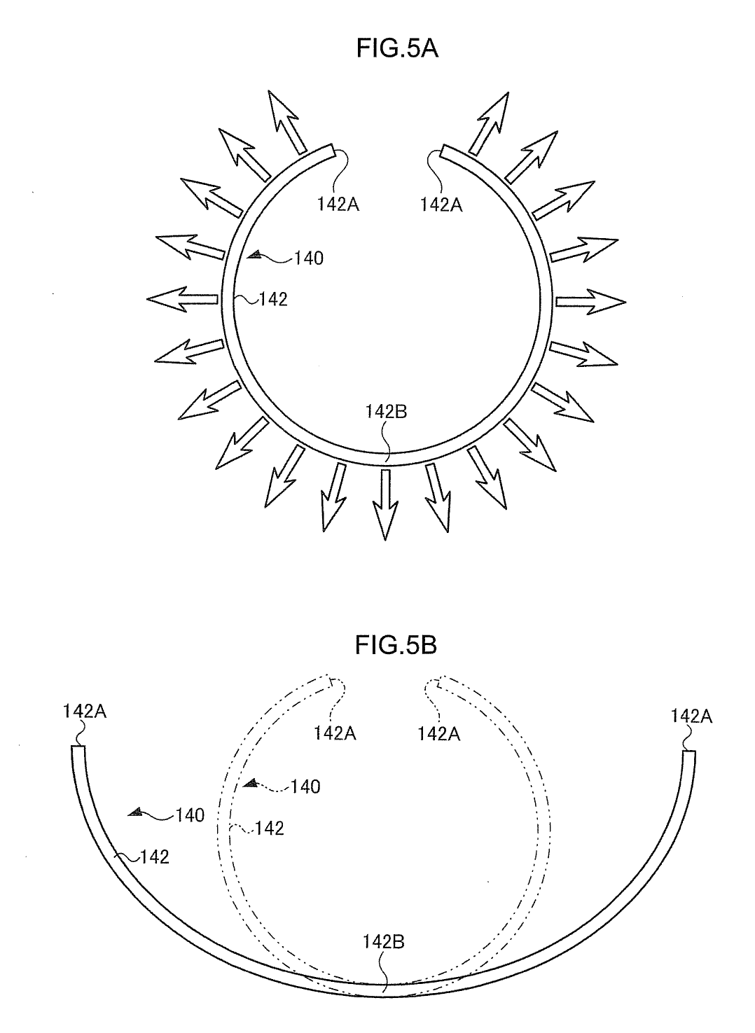

Here, the configuration of the reduction sliding spring 140 is shown by front views in FIGS. 5A and 5B. A solid line of FIG. 5B shows the unloaded state (state in which the spring is not elastically deformed) of the reduction sliding spring 140, and an imaginary line (two-dotted chain line) of FIG. 5B shows a state where the reduction sliding spring 140 has been elastically deformed in order to arrange the reduction sliding spring 140 between the outermost layer portion and second layer portion of the reduction balance spring 130.

As shown in FIGS. 5A and 5B, the reduction sliding spring 140 in the present embodiment is constituted by a pressure-contacting portion 142. The pressure-contacting portion 142 is made from a metal plate material or the like which is elastically bendable around an axis having the width direction as its axial direction. The pressure-contacting portion 142 is formed in the shape of a narrow plate, in which the longitudinal direction runs along the circumferential direction of the rotation of the ratchet gear 92 and the width direction runs along the direction of the rotation axis of the ratchet gear 92.

Since the reduction balance spring 130 has a spiral shape as shown in FIG. 4, the second layer portion of the reduction balance spring 130 is located inside the outermost layer portion. Accordingly, the portion between the outermost layer portion and second layer portion of the reduction balance spring 130 is also spiral, and the portion between the outermost layer portion and the second layer portion of the reduction balance spring 130 is displaced toward the center of rotation of the ratchet gear 92 gradually from the outside in the spiral direction to the inside in the spiral direction. However, since the amount of displacement is small, the amount of displacement is such that the displacement is considered as being substantially circular.

For this reason, as shown in FIGS. 5A and 5B, the pressure-contacting portion 142 (reduction sliding spring 140) is arranged between the outermost layer portion and second layer portion of the reduction balance spring 130 in the state of having been elastically deformed substantially in a circular shape. As shown by the solid line in FIG. 5B, the pressure-contacting portion 142 (reduction sliding spring 140) in a state in which the pressure-contacting portion has not been elastically deformed substantially in a circular shape is formed in the shape of a curve of which the radius of curvature becomes gradually larger in a predetermined ratio toward a longitudinal central portion 142B from both longitudinal ends 142A of the pressure-contacting portion 142 (reduction sliding spring 140).

Moreover, as shown in FIGS. 2 to 4, a clutch 150 which constitutes a rotation transmission member serving as a rotation transmission member is provided further inside a portion (innermost portion of the spiral) of an innermost layer of the reduction balance spring 130 in the spiral direction. The clutch 150 includes a spring case 152. The spring case 152 is formed in the shape of a bottomed cylinder which opens toward the leg plate 16. The spring case 152 is supported by the portion, which is located closer to the leg plate 16 side than the bottom wall portion 94, in the boss 96 formed in the bottom wall portion 94 of the ratchet gear 92 so as to be relatively rotatable coaxially with the ratchet gear 92.

The shaft portion 104 of the adapter 56 passes through the bottom wall of the spring case 152, and is supported by the shaft portion 104 so as to be relatively rotatable coaxially with the shaft portion 104. As shown in FIGS. 3 and 4, the inner end of the reduction balance spring 130 in the spiral direction is locked to the spring case 152.

Additionally, the clutch 150 includes a clutch wheel 154 as shown in FIG. 1. The clutch wheel 154 includes a cylindrical clutch wall 156, the clutch wall 156 enters the inside of the spring case 152 in the state of being coaxial with the bearing 102, and the clutch wheel 154 is assembled to the spring case 152 in this state. Additionally, a non-circular rotation-stop portion 158 interposed between a main body portion of the adapter 56 and the bearing 102 passes through the clutch wheel 154, and regulates the relative rotation of the clutch wheel 154 to the adapter 56.

A clutch spring 160 is arranged inside the above spring case 152 and outside the clutch wall 156. The clutch spring 160 is formed in the shape of a coil of which the axial direction becomes the same direction as the axial direction of the spool 18, and an end of the clutch spring is locked to the spring case 152. In a case where the clutch spring 160 is regarded to have a cylindrical shape, its internal diameter dimension is substantially equal to the external diameter dimension of the clutch wall 156, and the clutch spring 160 comes into sliding contact with the outer peripheral portion of the clutch wall 156. Moreover, the winding direction of a coil is set so as to be wound and tightened due to another end of the clutch spring 160 displaced in the take-up direction with respect to the one end of the clutch spring.

<Working and Effects of Present Embodiment>

Next, working and effects of the present embodiment will be described.

(Operation of Tension Reducer 22)

In the webbing take-up device 10, when an occupant who has sat down on a seat of a vehicle pulls the webbing belt 20 toward its tip to pull the webbing belt 20 out from the spool 18 in order to wear the webbing belt 20 on his/her body, the spool 18 rotates in the pull-out direction. When the spool 18 rotates in the pull-out direction, the adapter 56 rotates in the pull-out direction to rotate the inner end, in the spiral direction, of the take-up spring 50 in the pull-out direction with respect to the outer end of the take-up spring 50 in the spiral direction. Thereby, the take-up spring 50 is wound and tightened, and the biasing force which biases the spool 18 in the take-up direction via the adapter 56 increases gradually.

Additionally, as the adapter 56 rotates in the pull-out direction in this way, the clutch wheel 154 rotates in the pull-out direction. Since the clutch spring 160 comes into sliding contact with the outer peripheral portion of the clutch wall 156 of the clutch wheel 154, when the clutch spring 160 rotates in the pull-out direction along with the clutch wall 156 due to the friction between the outer peripheral portion of the clutch wall 156, and the clutch spring 160, the spring case 152 to which one end of the clutch spring 160 is locked rotates in the pull-out direction.

Since the inner end of the reduction balance spring 130 in the spiral direction is locked to the spring case 152, when the spring case 152 rotates in the pull-out direction, the inner end of the reduction balance spring 130 in the spiral direction rotates in the pull-out direction. The outermost layer portion of the reduction balance spring 130 is brought into pressure contact with the inner peripheral portion of the ratchet portion 106 of the reduction spring unit 90 by the elasticity of the reduction sliding spring 140 (pressure-contacting portion 142) which has been elastically deformed until the reduction sliding spring has a substantially circular shape.

For this reason, when the inner end of the reduction balance spring 130 in the spiral direction rotates in the pull-out direction, the outermost layer portion of the reduction balance spring 130 rotates in the pull-out direction, and the ratchet gear 92 rotates in the pull-out direction due to the friction between the outermost layer portion of the reduction balance spring 130 and the inner peripheral portion of the ratchet portion 106. That is, in this state, even if the rotational force of the spool 18 in the pull-out direction is transmitted to the ratchet gear 92, the ratchet gear 92 only rotates in the pull-out direction, and a change is not particularly generated in the reduction balance spring 130.

Next, when the webbing belt 20 is pulled out enough and is hung around the occupant's body, and the tongue provided at the webbing belt 20 is mounted on the buckle device, the ECU brings the solenoid 110 into an energized state on the basis of an electrical signal from the buckle switch provided at the buckle device. When the plunger 112 is drawn into the solenoid 110 by the magnetic field formed as the solenoid 110 is energized, the pawl 114 in which the connecting piece 122 engages with the tip of the plunger 112 turns in the engaging direction against the biasing force of the return spring 124. Thereby, when the rotation regulating piece 120 of the pawl 114 engages with the ratchet gear teeth formed on the outer peripheral portion of the ratchet portion 106, the rotation of the ratchet gear 92 in the take-up direction is regulated.

In this state, when the occupant ends the pulling force applied to the webbing belt 20 in order to pull out the webbing belt 20 (when the occupant stops the pulling of the webbing belt 20), the take-up spring 50 rotates the spool 18 in the take-up direction via the adapter 56 by its biasing force, thereby removing the slack from the webbing belt 20. When the clutch wheel 154 rotates in the take-up direction as the adapter 56 is rotated in the take-up direction, the other end of the clutch spring 160 rotates in the take-up direction due to the friction with the clutch wall 156, and thereby, the clutch spring 160 is wound and tightened.

When the friction between the clutch spring 160 and the clutch wall 156 increases as the clutch spring 160 is wound and tightened, the whole clutch spring 160 rotates in the take-up direction along with the clutch wall 156 (i.e., the clutch wheel 154). When the spring case 152 rotates in the take-up direction as the clutch spring 160 rotates in the take-up direction, the inner end of the reduction balance spring 130 in the spiral direction locked to the spring case 152 rotates in the take-up direction.

The outermost layer portion of the reduction balance spring 130 is brought into pressure contact with the inner peripheral portion of the ratchet portion 106 by the elasticity of the reduction sliding spring 140 (pressure-contacting portion 142) which has been elastically deformed until the reduction sliding spring 140 has a substantially circular shape, and the rotation of the ratchet gear 92 in the take-up direction is regulated as described above. For this reason, even if the inner end of the reduction balance spring 130 in the spiral direction rotates in the take-up direction in this state, the outermost layer portion of the reduction balance spring 130 does not rotate due to the friction with the inner peripheral portion of the ratchet portion 106, or has a rotational amount smaller than that of the inner end in the spiral direction. As for the reduction balance spring 130, the direction to the inside in the spiral direction from the outside in the spiral direction becomes the take-up direction. For this reason, when the inner end of the reduction balance spring 130 in the spiral direction rotates in the take-up direction relatively to the outer end in the spiral direction, the reduction balance spring 130 is wound and tightened, and thereby, the biasing force to rotate the inner end in the spiral direction in the pull-out direction increases.

The biasing force of the reduction balance spring 130 which is generated (increased) in this way resists the force to rotate the spring case 152 to which the inner end of the reduction balance spring 130 in the spiral direction is locked in the take-up direction, i.e., the biasing force of the take-up spring 50.

Moreover, when the reduction balance spring 130 is wound and tightened until the reduction balance spring perfectly comes into close contact with the outer peripheral portion of the spring case 152, the outermost layer of the reduction balance spring 130 and the reduction sliding spring 140 are integrally rotated by a rotational force in the take-up direction which is transmitted to the reduction balance spring 130 via the spring case 152 after this state.

As some or all of biasing force of the take-up spring 50 is offset by the biasing force of the reduction balance spring 130 in this way, the force to rotate the spool 18 in the take-up direction decreases, and the force to pull the webbing belt 20 applied to the occupant's body to its tip decreases. This reduces the force (static fastening force) that the webbing belt 20 applies to the occupant.

Additionally, when the body of the occupant wearing the webbing belt 20 moves, the webbing belt 20 is pulled out. When the spool 18 rotates in the pull-out direction as the webbing belt 20 is pulled out, the take-up spring 50 is wound and tightened, and the force which biases the spool 18 in the take-up direction, and thus the force to pull the webbing belt 20 to fasten the occupant's body increases. However, in the webbing take-up device 10, the biasing force of the reduction balance spring 130 offsets the biasing force of the take-up spring 50. Thus, an increase in the fastening force (dynamic fastening force) of the webbing belt 20 when the occupant's body moves and pulls the webbing belt 20 can be suppressed.

Meanwhile, in the present embodiment, the reduction sliding spring 140 (pressure-contacting portion 142) which has been elastically deformed until the inner and outer peripheral shapes thereof become a substantially circular shape is brought into pressure contact with the outermost layer portion of the reduction balance spring 130 by a force causing it to return to its original shape, i.e., an elastic force, and the relative rotation between the reduction balance spring 130 and the ratchet portion 106 is suppressed by the friction between the outermost layer portion of the reduction balance spring 130 and the inner peripheral portion of the ratchet portion 106 by bringing the outermost layer portion of the reduction balance spring 130 into pressure contact with the inner peripheral portion of the ratchet portion 106. Thereby, when the inner end of the reduction balance spring 130 in the spiral direction rotates in the take-up direction in a state where the rotation of the ratchet gear 92 in the take-up direction is regulated, the reduction balance spring 130 can be wound and tightened.

Here, the reduction sliding spring 140 (pressure-contacting portion 142) in the present embodiment is formed in the shape of a curve of which the radius of curvature becomes gradually larger in a predetermined ratio toward the longitudinal central portion 142B from both longitudinal ends 142A in a state in which the reduction sliding spring 140 has not been elastically deformed substantially in a circular shape. For this reason, the amount of elastic deformation accompanying a minute change in position from the longitudinal central portion 142B to both longitudinal ends 142A becomes approximately equal in a state where the reduction sliding spring 140 (pressure-contacting portion 142) has been elastically deformed substantially in a circular shape. As a result, a radially outward elastic force having substantially the center of the reduction sliding spring 140 as its center becomes approximately equal.

Thereby, the force (contact pressure) when the outermost layer portion of the reduction balance spring 130 is pressed against the inner peripheral portion of the ratchet portion 106 becomes approximately equal within a range where the outermost layer portion faces the reduction sliding spring 140 along the direction of the radius of rotation of the ratchet portion 106. For this reason, within this range, a difference is small in the magnitude of the frictional force between the reduction sliding spring 140 and the inner peripheral portion of the ratchet portion 106, and the brake force which regulates the displacement of the outermost layer portion of the reduction balance spring 130 in the circumferential direction on the basis of this frictional force is stabilized.

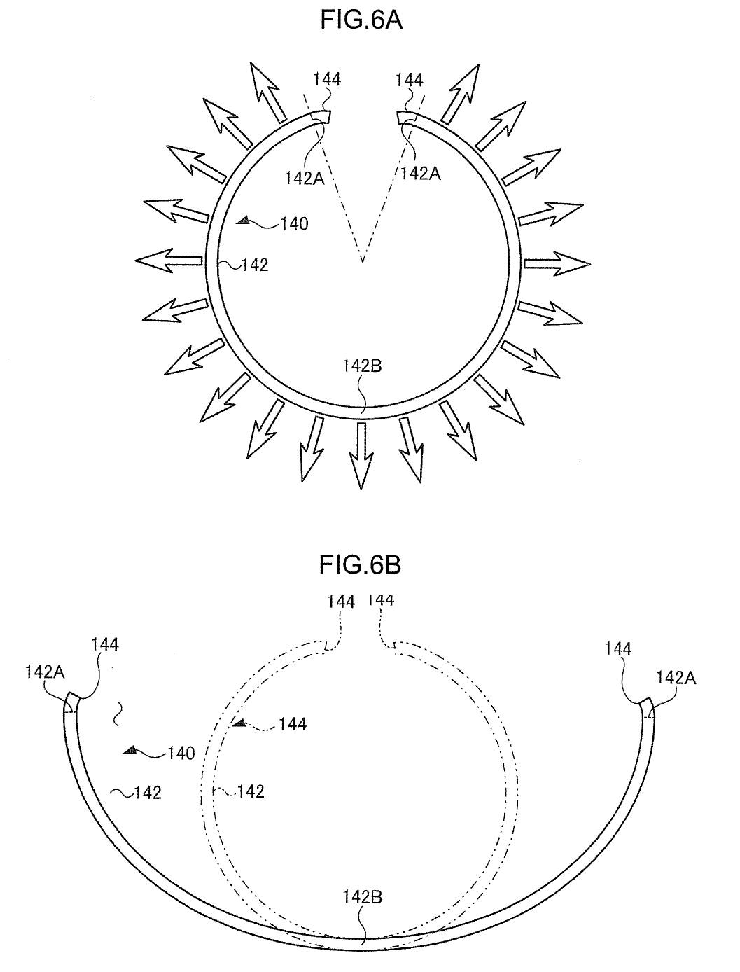

In addition, in the present embodiment, the reduction sliding spring 140 is constituted only by the pressure-contacting portion 142. However, for example, as shown in FIGS. 6A and 6B, in a state where the pressure-contacting portion 142 has been elastically deformed substantially in a circular shape, separation portions 144 of which the tips are directed to the inside of the pressure-contacting portion 142 may be continuously formed from both longitudinal ends of the pressure-contacting portion 142, and the reduction sliding spring 140 may be constituted by the pressure-contacting portion 142 and the separation portions 144.

When the separation portions 144 are formed in this way, it is possible to prevent corners or the like of the longitudinal ends of the reduction sliding spring 140 from contacting the outermost layer portion of the reduction balance spring 130 at the corners.

What is claimed is:

1. A webbing take-up device comprising:
a spool having a longitudinal base end of an elongated belt-shaped webbing belt locked thereto, taking up the webbing belt from the base end by rotating in a take-up direction, and rotating in a pull-out direction opposite to the take-up direction as the webbing belt is pulled out;
a spool biasing member biasing the spool in the take-up direction by a take-up biasing force which increases with the rotation of the spool in the pull-out direction;
a rotating body formed in a bottomed shape having a peripheral wall whose inner peripheral shape is circular, and rotating around an axis having the same axial direction as an axial direction of the spool, the rotation of the rotating body according to the rotation of the spool in the take-up direction being regulated in a state where the webbing belt is applied to an occupant's body;
a spiral spring provided inside the rotating body, the spiral spring having an inner end in a spiral direction connected directly or indirectly to the spool, the inner end in the spiral direction being wound around and tightened to an outer end in the spiral direction as the spool rotates in the take-up direction in a state where the rotation of the rotating body is regulated, such that a biasing force biasing the spool in the pull-out direction is generated; and
a pressure-contact biasing member biasing an outermost layer portion located at a outermost side in the spiral spring radially outward from a center of an inner peripheral portion of the rotating body, and pressing the outermost layer portion to contact with the inner peripheral portion of the rotating body, the biasing force being substantially uniformly set in a circumferential direction of the inner peripheral portion.

2. The webbing take-up device according to claim 1, wherein the pressure-contact biasing member is provided with a spring member; the spring member is bent with a radial inside of the inner peripheral portion of the rotating body as a center of radius of curvature;
the spring member is provided between the outermost layer portion of the spiral spring and a second layer portion adjacent to the outermost layer portion further toward an inner side in the spiral direction than the outermost layer portion in the state of being elastically deformed, such that a radius of curvature on a central side is set to be larger than on both end sides in the circumferential direction and a difference in the radius of curvature between both end sides in the circumferential direction and the central side is decreased; and the spring member biases the outermost layer portion radially outward by the biasing force generated by being elastically deformed.

3. The webbing take-up device according to claim 2, wherein the shape of the spring member is set such that both ends of the spring member are located inward so as to be separated from the outermost layer portion of the spiral spring in a state where the spring member has been elastically deformed substantially in a circular shape.
